(19) United States
(12) Patent Application Publication
(10) Pub. No.: US 2026/0302284 A1
(43) Pub. Date: Oct. 1, 2026

(54) SOLID POLYMER FUEL BATTERY ACTIVATION METHOD

(71) Applicant: HONDA MOTOR CO., LTD., Tokyo (JP)

(72) Inventors: Ryo Mochizuki, Wako-shi (JP); Ken Tagawa, Wako-shi (JP); Shinsaku Takikawa, Wako-shi (JP); Takuro Sasaki, Wako-shi (JP)

(21) Appl. No.: 19/550,319

(22) Filed: Feb. 26, 2026

(30) Foreign Application Priority Data
Mar. 31, 2025 (JP) 2025-059371

(51) Int. Cl. H01M 8/04223; H01M 8/10

(52) U.S. Cl. CPC H01M 8/04223; H01M 2008/1095

(57) ABSTRACT

A solid polymer fuel battery activation method is an activation method of a solid polymer fuel battery that includes an anode electrode, a cathode electrode, and a solid polymer membrane arranged between the anode electrode and the cathode electrode, the solid polymer fuel battery activation method including: a first step in which air is uniformly supplied to an entirety of the cathode electrode; and a second step in which, in a state where the air is uniformly supplied to the entirety of the cathode electrode, a certain amount of current is caused to flow for a certain period of time to the cathode electrode from the anode electrode by an external electric power source, and then the flowing of the current is stopped, wherein a combination of the first step and the second step is repeated twice or more times.

### CROSS-REFERENCE TO RELATED APPLICATION

Priority is claimed on Japanese Patent Application No. 2025-059371, filed on Mar. 31, 2025, the contents of which are incorporated herein by reference.

### BACKGROUND

### Field of the Invention

The present invention relates to a solid polymer fuel battery activation method.

### Background

In the related art, efforts aiming at reduction of the impact on or moderation of climate change have been ongoing, and toward the realization of this purpose, research and development relating to reduction of carbon dioxide emissions has been conducted. From such a viewpoint, a fuel cell vehicle (FCV) on which a fuel battery is mounted has been attracting attention. This is because the substance discharged from the fuel cell vehicle is only water (H₂O) is, and gases such as CO₂, NO_{X}, and SO_{X} are not discharged.

In general, a fuel battery mounted on the fuel cell vehicle has a fuel battery stack. The fuel battery stack is obtained by stacking a plurality of fuel battery cells having a flat plate shape. Each fuel battery cell has a membrane electrode assembly (MEA) and a pair of separators arranged on both sides of the membrane electrode assembly.

The membrane electrode assembly includes a solid polymer electrolyte membrane (hereinafter, referred to as an electrolyte membrane) having a first end surface and a second end surface, an anode electrode (fuel electrode) provided on the first end surface of the electrolyte membrane, and a cathode electrode (oxidant electrode) provided on the second end surface of the electrolyte membrane. That is, the membrane electrode assembly is constituted such that the electrolyte membrane is sandwiched between the anode electrode and the cathode electrode.

In the fuel battery, hydrogen is supplied to the anode electrode of the membrane electrode assembly as an anode gas (fuel). Further, a cathode gas (oxidant) containing oxygen such as air is supplied to the cathode electrode of the membrane electrode assembly. Then, hydrogen ions generated by a reaction between hydrogen and a catalyst at the anode electrode pass through the electrolyte membrane, move to the cathode electrode, cause an electrochemical reaction (O₂ + 4H⁺ + 4e⁻ → 2H₂O) with oxygen in the cathode gas at the cathode electrode, and generate electric power. Accordingly, in each fuel battery cell, water is generated in accordance with the electric power generation.

In the fuel battery, commonly, activation (aging operation) of the fuel battery cell is performed before the first operation. By performing the activation of the fuel battery cell, hydrogen ions and the like can easily move in the fuel battery cell, and a sufficient electric power generation performance can be obtained.

As an activation method of the fuel battery cell, for example, there is a method of supplying hydrogen to the anode electrode as an anode gas and introducing a mixed gas of nitrogen and air to the cathode electrode as a cathode gas.

Paragraph 0059 (Example) of Japanese Unexamined Patent Application, First Publication No. 2005-340022 describes that in an aging process of a solid electrolyte fuel battery, “… after starting electric power generation, a load was applied to a fuel battery in a step-by-step manner by using an electronic load device connected to the fuel battery. Then, when 5 minutes had passed since the start of electric power generation, application of a load that has a square wave form and periodically varies to the fuel battery was started. … As shown in FIG. 4, the load pattern … the application of the load having the square wave form was performed for 15 minutes, and then, the state is set to steady electric power generation in which a load of 0.15 mA/cm² in terms of a current density was continuously applied”.

Paragraph 0033 of Japanese Unexamined Patent Application, First Publication No. 2019-197690 describes that “… by short-circuiting an anode catalyst layer and a cathode catalyst layer, a short-circuit current having a current density of 2 A/cm² or more flows through a fuel battery only for a short time of 1 second or less (part III in FIGS. 4 and 5) …, a step is added, and the processes of Steps S10 to S20 are repeatedly performed a plurality of times as shown in FIG. 3”.

Paragraph 0046 of Japanese Unexamined Patent Application, First Publication No. 2010-027296 describes that “By controlling a current source with a control device, a current that flows out of an air electrode is controlled such that a potential of the air electrode becomes a potential waveform shown in FIG. 9 (B)”, and paragraph 0052 describes that the air electrode potential is periodically varied by current application.

### SUMMARY

In the fuel battery activation method of the related art, since the supply amount of air to the cathode electrode is small, the electrochemical reaction described above is biased to an upstream side (a side to which air is supplied) of the cathode electrode, and activation of the fuel battery is insufficient on a downstream side of the cathode electrode.

An aspect of the present invention aims at providing a solid polymer fuel battery activation method that can activate a fuel battery in the entirety of a cathode electrode.

An aspect of the present invention is a solid polymer fuel battery activation method which is an activation method of a solid polymer fuel battery that includes an anode electrode, a cathode electrode, and a solid polymer membrane arranged between the anode electrode and the cathode electrode, the solid polymer fuel battery activation method including: a first step in which air is uniformly supplied to an entirety of the cathode electrode; and a second step in which, in a state where the air is uniformly supplied to the entirety of the cathode electrode, a certain amount of current is caused to flow for a certain period of time to the cathode electrode from the anode electrode by an external electric power source, and then the flowing of the current is stopped, wherein a combination of the first step and the second step is repeated twice or more times.

According to the aspect described above, the fuel battery can be activated with respect to the entirety of the cathode electrode.

According to the aspect of the present invention, it is possible to provide a solid polymer fuel battery activation method that can activate a fuel battery with respect to the entirety of a cathode electrode.

### BRIEF DESCRIPTION OF THE DRAWINGS

FIG. 1 is a cross-sectional view schematically showing a fuel battery cell of a fuel battery that is activated by a solid polymer fuel battery activation method according to an embodiment of the present invention.

FIG. 2 is a view showing the solid polymer fuel battery activation method according to the embodiment of the present invention.

### DESCRIPTION OF EMBODIMENTS

Hereinafter, an embodiment of the present invention will be described in detail with reference to the drawings.

### Solid polymer fuel battery activation method

A solid polymer fuel battery activation method according to an embodiment of the present invention is an activation method of a solid polymer fuel battery that includes an anode electrode, a cathode electrode, and a solid polymer membrane arranged between the anode electrode and the cathode electrode, the solid polymer fuel battery activation method including: a first step in which air is uniformly supplied to an entirety of the cathode electrode; and a second step in which, in a state where the air is uniformly supplied to the entirety of the cathode electrode, a certain amount of current is caused to flow for a certain period of time to the cathode electrode from the anode electrode by an external electric power source, and then the flowing of the current is stopped, wherein a combination of the first step and the second step is repeated twice or more times.

The solid polymer fuel battery activation method of the present embodiment is a method of activating a plurality of stacked fuel battery cells 30. The plurality of fuel battery cells 30 are connected, for example, in series.

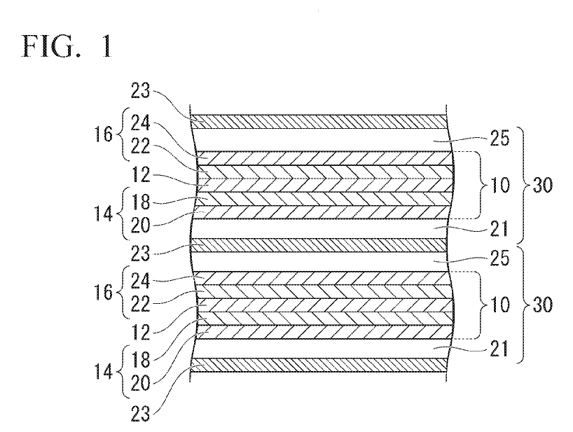

The present embodiment is described using the case where a plurality of fuel battery cells 30 are stacked as an example; however, only one layer of a fuel battery cell 30 may be used. Further, in the case where the fuel battery cells 30 are stacked as shown in FIG. 1, the stack number of fuel battery cells 30 is not particularly limited.

### Fuel battery cell 30

As shown in FIG. 1, the fuel battery cell 30 (solid polymer fuel battery cell) has a first separator 21, a second separator 25, and a membrane electrode assembly (MEA) 10 arranged between the first separator 21 and the second separator 25.

Each of the first separator 21 and the second separator 25 is made of, for example, a known fuel battery separator such as a metal separator made of stainless steel, aluminum, titanium, or the like, or a carbon separator.

As shown in FIG. 1, the membrane electrode assembly 10 has an anode electrode 14, a cathode electrode 16, and a solid polymer electrolyte membrane 12 (solid polymer membrane) sandwiched between the anode electrode 14 and the cathode electrode 16.

The solid polymer electrolyte membrane 12 is made of an ion exchange membrane having proton conductivity. Specifically, as the solid polymer electrolyte membrane 12, for example, a membrane made of a fluorine system resin such as perfluorosulfonic acid, a hydrocarbon system resin, or the like can be used.

As shown in FIG. 1, the anode electrode 14 has a first electrode catalyst layer 18 and a first gas diffusion layer 20 for supplying a gas to the first electrode catalyst layer 18.

The cathode electrode 16 has a second electrode catalyst layer 22 and a second gas diffusion layer 24 for supplying a gas to the second electrode catalyst layer 22.

As each of the first electrode catalyst layer 18 and the second electrode catalyst layer 22, for example, a layer in which a catalyst is supported by a carrier such as carbon particles or the like can be used. Examples of the catalyst contained in the first electrode catalyst layer 18 and the second electrode catalyst layer 22 include a platinum catalyst, a platinum alloy catalyst made of platinum and another metal, and the like. In the present embodiment, one or both of the first electrode catalyst layer 18 and the second electrode catalyst layer 22 can preferably contain a platinum catalyst. This is because a fuel battery having a sufficient electric power generation performance can be obtained by activating the fuel battery cell 30.

As each of the first gas diffusion layer 20 and the second gas diffusion layer 24, for example, a known fuel battery diffusion layer such as a carbon cloth using a carbon non-woven fabric or a carbon paper can be used.

A cooling water flow path 23 through which cooling water for cooling the fuel battery cell 30 flows is provided between two fuel battery cells 30 that are adjacent to each other.

Next, a solid polymer fuel battery activation method of the present embodiment is described.

The reason why it is necessary to perform activation (aging) of the fuel battery is described. The initial electric power generation performance of a fuel battery is low due to a resistance of an initial dried electrolyte membrane, an oxide film formed on a catalyst in a manufacturing process, and poisoning of the catalyst by a volatile organic substance. Therefore, after the fuel battery is manufactured, in order to obtain a desired electric power generation performance, a preliminary operation (running-in operation) referred to as aging of the fuel battery is usually performed. The aging of the fuel battery is to cause the fuel battery to be able to exhibit a desired performance by wetting the electrolyte membrane, reducing the resistance of the electrolyte membrane, and removing the organic substance and the oxide film on a catalyst surface by preliminarily performing electric power generation of the fuel battery after manufacturing the fuel battery. Further, not only after the manufacturing but also, for example, when electric power generation is performed again (at the time of restart) after pausing of the fuel battery (particularly, after pausing for a long time) or when output characteristics such as an electromotive force are deteriorated by electric power generation for a long time, the output characteristics of the fuel battery may be recovered by performing aging.

### First step

In a first step, air is uniformly supplied to the entirety of the cathode electrode of the solid polymer fuel battery.

As a method of uniformly supplying air to the entirety of the cathode electrode, for example, a method of setting the concentration of oxygen contained in the air to 5% or less can be used. Alternatively, the concentration of oxygen contained in the air is increased as much as possible in a range in which a current is not excessively caused to flow to the cathode electrode. Since an equipment cost is increased when the oxygen concentration is increased, it is better that the oxygen concentration is the minimal amount, and therefore, the oxygen concentration is set in consideration of a target cost.

### Second step

In a second step, in a state where the air is uniformly supplied to the entirety of the cathode electrode, a certain amount of current is caused to flow for a certain period of time to the cathode electrode from the anode electrode by an external electric power source, and then the flowing of the current is stopped.

In the earliest stage of the second step, there is a zone where the current distribution is uniform in the cathode electrode, but then, the current distribution gradually becomes non-uniform, and there may be cases in which the fuel battery cannot be activated in the entirety of the cathode electrode. Therefore, when the current distribution becomes constant, the flowing of the current from the anode electrode to the cathode electrode is once stopped, the first step is performed again, and then, the performing of the second step is repeated. Thereby, the fuel battery can be activated in the entirety of the cathode electrode. The number of times of repeating the combination of the first step and the second step is two or more. By repeating the combination of the first step and the second step twice or more times, the fuel battery can be further activated in the entirety of the cathode electrode than the case where the combination of the first step and the second step is performed only once.

The number of times and the time of repeating the combination of the first step and the second step are not particularly limited. Commonly, the time of repeating the combination of the first step and the second step is, for example, equal to or more than 10 minutes and equal to or less than 40 minutes. When the time of repeating the combination of the first step and the second step is too short, the activation of an all-solid-state battery to a predetermined output is not completed. On the other hand, when the time of repeating the combination of the first step and the second step is too long, an increase in an unnecessary repetition time occurs. Therefore, the number of times and the time of repeating the combination of the first step and the second step are determined by comprehensively determining the target output and the repetition time.

In the solid polymer fuel battery activation method of the present embodiment, the activation completion of the solid polymer fuel battery is determined by the output evaluation by electric power generation.

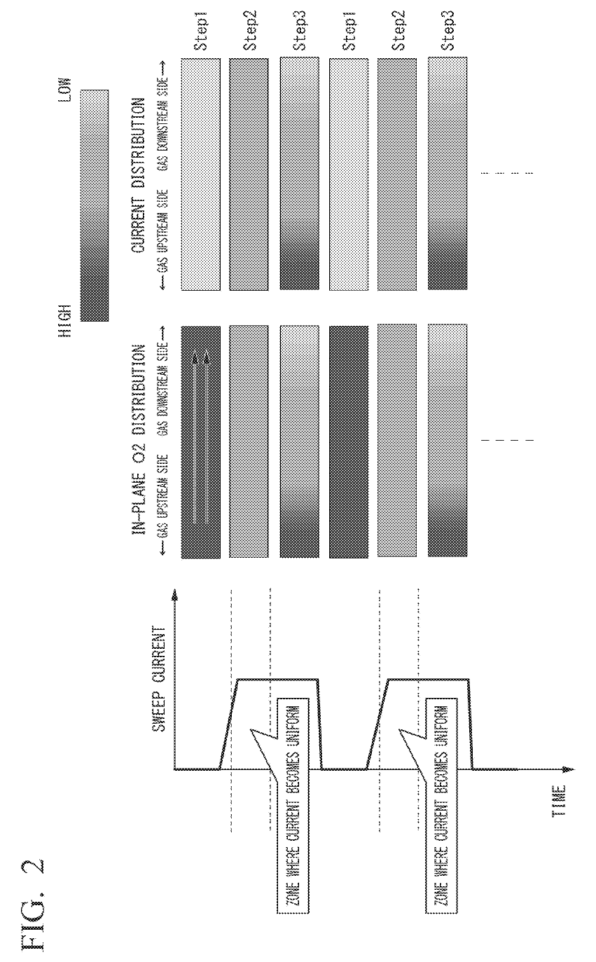

A specific example of the solid polymer fuel battery activation method of the present embodiment is described with reference to FIG. 2.

FIG. 2 is a view showing the solid polymer fuel battery activation method of the present embodiment. In an upper right portion of FIG. 2, an indicator indicating the concentration of oxygen on one surface of the cathode electrode and a current that flows through the cathode electrode is displayed. In the indicator, the concentration of oxygen and the current are decreased from the left side toward the right side of the drawing.

In Step 1, air is supplied to the cathode electrode of the solid polymer fuel battery. In Step 1, the concentration of oxygen is uniform over the entirety of the cathode electrode. Further, in Step 1, a current is not caused to flow from the anode electrode to the cathode electrode.

In Step 2, when a current is caused to flow from the anode electrode to the cathode electrode, a current that flows through the cathode electrode is increased over the entirety of the cathode electrode. This is because oxygen is present over the entirety of the cathode electrode, and therefore, an electrochemical reaction between hydrogen ions and oxygen progresses over the entirety of the cathode electrode. On the other hand, since the electrochemical reaction progresses, the concentration of oxygen is decreased in the entirety of the cathode electrode. Further, as the electrochemical reaction progresses, the current that flows through the cathode electrode becomes constant in due course.

In Step 3, since the supply amount of air is increased on an upstream side of the cathode electrode and the supply amount of air is decreased on a downstream side of the cathode electrode, the electrochemical reaction described above is biased to the upstream side of the cathode electrode. As a result, the current that flows through the upstream is of the cathode electrode is increased, and the current that flows through the downstream side of the cathode electrode is decreased.

When such a state is reached, the flowing of the current from the anode electrode to the cathode electrode is stopped, the routine returns to Step 1 again, and air is uniformly supplied to the entirety of the cathode electrode. Then, Step 2 and Step 3 are performed.

When the activation completion of the solid polymer fuel battery is confirmed, Step 3 is ended. When the activation completion of the solid polymer fuel battery is not confirmed, Step 1 to Step 3 are repeated again.

Although the embodiment of the present invention has been described in detail, the present invention is not limited to the embodiment described above, and various modifications and changes can be made within the scope of the gist of the present invention described in the claims.

What is claimed is:

1. A solid polymer fuel battery activation method which is an activation method of a solid polymer fuel battery that comprises an anode electrode, a cathode electrode, and a solid polymer membrane arranged between the anode electrode and the cathode electrode, the solid polymer fuel battery activation method comprising:
a first step in which air is uniformly supplied to an entirety of the cathode electrode; and
a second step in which, in a state where the air is uniformly supplied to the entirety of the cathode electrode, a certain amount of current is caused to flow for a certain period of time to the cathode electrode from the anode electrode by an external electric power source, and then the flowing of the current is stopped,
wherein a combination of the first step and the second step is repeated twice or more times.
